(19) United States
(12) Patent Application Publication
(10) Pub. No.: US 2018/0162531 A1
(43) Pub. Date: Jun. 14, 2018

(54) WIND ESTIMATION USING REMOTELY-DROPPED DROPSONDE

(71) Applicant: The Charles Stark Draper Laboratory, Inc., Cambridge, MA (US)

(72) Inventors: Natalya Markuzon, Cambridge, MA (US); Mitchell Plyler, Cambridge, MA (US); Daniel Chen, Cambridge, MA (US); Kai Angermueller, Cambridge, MA (US)

(21) Appl. No.: 15/718,411

(22) Filed: Sep. 28, 2017

Related U.S. Application Data
(60) Provisional application No. 62/432,187, filed on Dec. 9, 2016.

(51) Int. Cl. B64D 1/08; G01W 1/08; G01W 1/10; G05D 1/10

(52) U.S. Cl. CPC B64D 1/08; G01W 1/08; B64D 17/025; G05D 1/105; G01W 1/10

(57) ABSTRACT

Payload delivery to a drop zone includes selecting a remote location at which to measure a remote wind stick and doing so based at least in part on current weather conditions. This is followed by determining a release point, flying to it, and then dropping the payload from the release point. Determining the release point includes estimating a wind stick at the drop zone based at least in part on the measurement of the remote wind stick.

### RELATED APPLICATIONS

This application claims the benefit of the Dec. 9, 2016 priority date of U.S. Provisional Application 62/432,187, the contents of which is incorporated herein by reference.

### FIELD OF INVENTION

The invention relates to air drops, and in particular, to determining when to release a payload.

### BACKGROUND

In many cases, it is desirable to deliver a payload by dropping it from an airplane. A difficulty that arises is making sure that the payload lands where it is intended to. This requires consideration of when the delivery airplane should release the payload.

One approach to determining when to release the payload is to rely on ballistics. Given the airplane's speed and altitude, the acceleration due to gravity, and the target location, it is a relatively simple matter to calculate the correct release point.

Unfortunately, the presence of wind tends to make this calculation inaccurate.

Another approach is to use wind forecasts to predict the wind in the vicinity of the drop zone. However, this method assumes the forecast is accurate at the local level. In many cases, the forecast has difficulty predicting winds at a local level, particularly as one approaches the ground.

A suitable way to overcome this difficulty is to use the delivery airplane to drop a dropsonde. As the dropsonde falls, it collects data concerning the conditions that it encounters and sends that data back to a processor on board the delivery airplane. The processor then calculates the optimal release point based on this data and proceeds to drop the payload from the release point.

A disadvantage of the foregoing method is that the airplane must now make two passes: a first one to drop the dropsonde and a second one to drop the payload. Aside from requiring more fuel, in some circumstances, this exposes the airplane to hostile fire twice instead of once, and pinpoints release location of a payload in advance.

### SUMMARY

In one aspect, the invention features a method that includes delivering a payload to a drop zone. The process of delivering the payload includes selecting a remote location at which to measure a remote wind stick and doing so based at least in part on current weather conditions. This is followed by determining a release point, flying to it, and then dropping the payload from the release point. The process of determining the release point includes estimating a wind stick at the drop zone based at least in part on the measurement of the remote wind stick.

Among the practices of this method are those that also include selecting a remote location at which to measure the remote wind stick, and to do so at least in part on the basis of a confidence level of the estimate of the wind stick at the drop zone. This confidence level is determined at least in part on the basis of the current weather conditions.

Also among the practices of the invention are those that include estimating a confidence level of the estimate of the wind stick at the drop zone based on the current weather conditions.

Also among the practices of this method are those that include releasing a dropsonde at the remote location, collecting data from the dropsonde, and determining the release point based at least in part on the collected data.

In yet other practices, determining the release point comprises providing the remote wind stick to an operational model that has been configured to provide a transformation based on historical weather data and applying the transformation to the remote wind stick to obtain an estimate of a drop-zone wind stick at the drop zone.

Some practices further include obtaining the operational model by providing a training model with historical weather data and simulated wind sticks.

Other practices include obtaining the operational model by providing a training model with training data, and using boosted regression trees to identify transformations to transform a measurement of a wind stick at a first location into an estimate of a wind stick at a second location.

In another aspect, the invention features a method that includes obtaining a first value of a variable, providing the first value to an operational model that has been configured by a machine-learning algorithm to provide a transformation to yield an estimate of a value of the variable at a second location, and transforming the first value of the variable to obtain a second value of the variable. The second value of the variable is an estimate of a value of the variable at a remote location. This first value is one that is obtained by measuring at a measurement location that differs from the remote location.

In some embodiments, the remote location is below a region that contains the measurement location. In other embodiments, the remote location and the measurement location are separated along a circumferential direction that is perpendicular to a line extending to the center of the Earth.

### BRIEF DESCRIPTION OF THE FIGURES

FIG. 1 shows an aircraft dropping a dropsonde at a remote site;

FIG. 2 shows the aircraft of FIG. 1 releasing a payload based at least in part on data received from the dropsonde; and

FIG. 3 summarizes the creation of an operational model through machine learning based on historical data.

### DETAILED DESCRIPTION

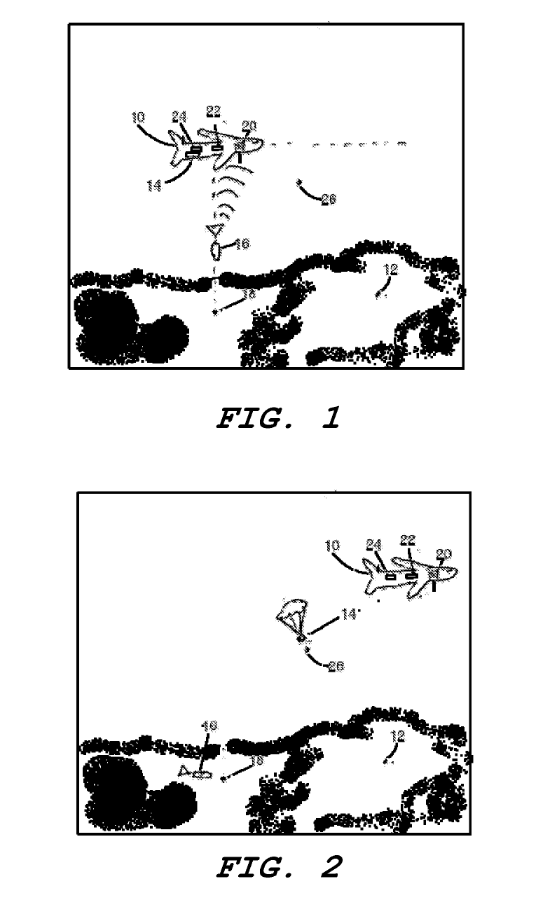

FIG. 1 shows an aircraft 10 flying towards a drop zone 12 to deliver a payload 14 that is intended to land at the drop zone 12. The aircraft 10 has recently dropped a dropsonde 16 toward a remote location 18 that is at some distance from the drop zone 12.

As the dropsonde 16 falls, it periodically measures wind vectors. The result is a set of wind vectors along the dropsonde's path. This set of wind vectors will be referred to herein as a “wind stick.” As shown in the figure, the dropsonde 16 transmits a first wind stick back to a receiver 20 on the aircraft 10. This first wind stick consists of wind vectors measured in the remote location 18.

Aboard the aircraft 10, a processor 22 receives, from the receiver 20, data representative of the first wind stick. The processor 22 then retrieves, from a memory 24, a suitable transformation. This transformation is obtained during a training phase of a machine-learning procedure to be discussed below. The processor 22 then applies this transformation to the first wind stick to obtain a second wind stick. This second wind stick represents an estimate of the wind present at the drop zone 12. Based on this second wind stick, the processor 22 determines an appropriate release point 26 at which the aircraft 10 should release the payload 14.

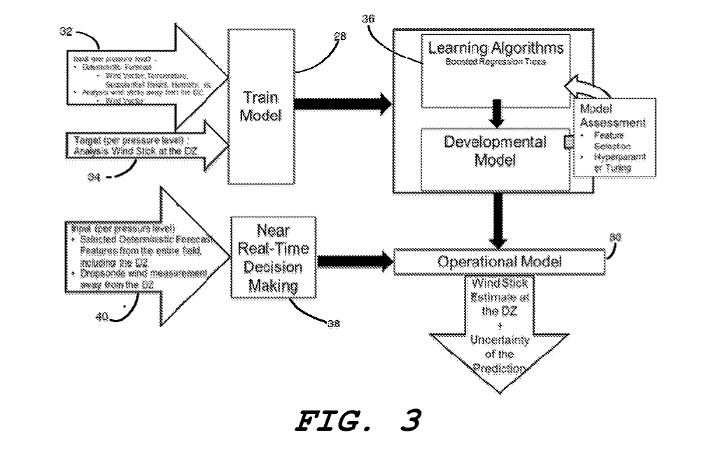

The aircraft 10 then continues until it reaches the release point 26, as shown in FIG. 2, at which point it releases the payload 14. The payload 14 then falls. As it does so, the prevailing wind causes it to drift. However, because of the transformation applied to the first vector, the prevailing wind should cause the payload 14 to drift in such a way as to land at or near the drop zone 12.

The distance between the remote location 18 and the drop zone 12 is essentially a race between the aircraft 10 and the processor. The shorter this distance is, the greater will be the accuracy of the estimate. On the other hand, sufficient time must be allotted for the processor 22 to actually determine the release point 26. Otherwise, the aircraft 10 have to circle around possibly hostile airspace while waiting for the processor 22 to complete its work. In a typical operating environment, a distance of approximately one-hundred kilometers has been found to be practical.

The process of providing a selection of transformations that can be applied to the first wind stick to estimate the second wind stick is the product of a training procedure in which a machine-learning algorithm uses historical data to identify a pattern of differences between a wind stick at a selected zone and a wind stick at a remote location 18.

Referring now to FIG. 3, the machine-learning method includes training a training-model 28 to create an operational model 30. The training procedure includes providing the training-model 28 with training data that includes historical data on both input features and the expected output 32, 34. In the particular embodiment shown, the historical data 32 includes a forecast grid. This includes deterministic forecast data for wind vectors, temperature, and humidity, as well as wind stick data away from the drop zone 12.

In the same particular embodiment, the expected output 34 is represented through analysis data that best estimates the actual wind stick over the drop zone 12. This will make it possible to estimate the error between the wind stick data from the historical data 32 and the target wind stick at the drop zone 34. This estimate in the error provides a basis for estimating uncertainty in the prediction at the drop zone. In general, this uncertainty varies with the weather conditions that prevailed at the time that the estimate was made.

The training proceeds with the application of any of a variety of data-mining and machine-learning algorithms 36. However, a particularly useful machine-learning algorithm 36 relies on boosted regression-trees. Such an algorithm has been found to accurately assimilate data obtained by a dropsonde from a remote location 18.

Accordingly, unlike conventional assimilation methods, which rely exclusively on static data, the method described in FIG. 3 is capable of adapting to the weather conditions on the day of the actual measurement, and to provide an estimate of the extent to which the predicted wind stick at the remote location 18 will match the actual wind stick at the drop zone 12.

The ability to estimate the extent of this match also provides a way to choose an optimal remote location 18 at which to measure a remote wind stick and to do so as a function of the weather conditions at the time of delivery of the payload to the drop zone 12. This differs from the conventional approach in which the optimal remote locations 18 are given in advance without having considered the actual weather conditions at the time of the delivery.

This distinction arises in part because the use of machine learning is able to avoid predictions based on static data that do not consider current weather conditions. As a result, the transformation that is applied to the measured wind stick at the remote location 18 need not be a static transformation that would be the same regardless of current weather conditions. Instead, it is a dynamic transformation that responds to current weather conditions. This offers a distinct advantage in environments in which local weather conditions exhibit high variance.

The model is trained on a pressure-level basis, with each pressure level generally corresponding to an altitude at which data is collected. It has been found that thirty pressure levels is adequate to for normal operation.

The data relied upon is by no means restricted to wind speed and direction. Any observable data is fair game for use in the training procedure. These observables include wind, temperature, and humidity forecasts in the vicinity of the drop zone 12 and the remote location 18, as well as similar features extracted from dropsonde data. A suitable and widely available source of data is that provided by NOAA based on historical weather maps. In addition, numerous other forms of data can be created using principal component analysis or other feature development methods. This uses data over an extended wind field evaluated within an area surrounding the drop zone 12. The extent of this area varies with local factors and desired performance. However, a suitable area is a circular area having a diameter of approximately one hundred kilometers.

Examples of data that have been found useful are listed below. In the following list, the first and second components of the wind vector are orthogonal and lie in a plane parallel to the Earth. Any component of the wind vector perpendicular to this plane is ignored, but in principle, need not be. The wind stick, being a set of wind vectors, is regarded as having a component that depends on its constituent wind vectors. Since each wind vector is a vector, it can be resolved into components that point in orthogonal directions. For example, a wind vector may have a component along a north-south direction and an orthogonal component along an east-west direction. As used herein, a “vector-component” is used to refer to any one of the constituent orthogonal components of a wind vector.

A humidity stick is a similar set of measurements of humidity, which, being a scalar, makes the humidity stick a scalar. The data that has been found useful for training includes:
dropsonde measurements of a first vector-component of the wind vector at a current pressure level,
the forecast error in the first vector-component of the wind vector at the remote location 18 based on the forecast for the same component of the wind vector at the drop zone 12,
principal-component analysis carried out on the first vector-component of the wind vector field at the current pressure level,
a similar principal-component analysis carried out on the first vector-component of the wind vector field one level below the current level,
a similar principal-component analysis but instead carried out on the first vector-component of the wind vector field one level above the current level,
the forecast mean of the second vector-component of the wind-vector stick at the remote location 18,
the variance in temperature at the current pressure level,
the forecast error in the second vector-component of the wind vector at the remote location 18,
the forecast variance in the first vector-component of the wind-vector stick at the remote location 18,
the forecast variance in the second vector-component of the wind-vector stick at the remote location 18,
the forecast variance in the first vector-component of the wind-vector stick at the drop zone 12,
the forecast error in the first vector-component of the wind at the remote location 18,
the forecast variance in the second vector-component of the wind-vector stick at the drop zone 12,
dropsonde measurements of the second vector-component of the wind vector at the current pressure level,
the mean relative humidity at the current pressure level,
the forecast of the mean of the first vector-component of the wind-vector stick at the drop zone 12,
the forecast for the second vector-component of the wind at the remote location 18,
the variance in the first vector-component of the wind vector at current pressure level,
the variance in relative humidity of a humidity stick at the remote location 18, and
the variance in relative humidity of a humidity stick at the drop zone 12.

The outcome of the training procedure is an operational model 30 that can be carried with the aircraft 10 and used for near-real time decision-making 38 based on operational measurements 40 that would include the dropsonde data referred to in connection with FIGS. 1 and 2. Such operational measurements 40 include, for example, selected deterministic forecast features from the entire field, including the drop zone 12, and wind measurements away from the drop zone 12 as provided by the dropsonde. The availability of these operational measurements 40, and in particular, the current weather conditions contained therein, makes it possible to dynamically assess the uncertainty of the wind prediction at the target by taking into account the weather conditions prevailing at the time of the estimate.

The preceding method thus amounts to spatial rather than temporal weather forecasting. In temporal weather forecasting, the question is usually, “Given the weather today, what will the weather be tomorrow?” In the method described herein, the question instead becomes, “Given the weather over here, what is the weather over there?”

The preceding method can also be regarded as a form of computational remote-sensing. In conventional remote-sensing, one makes a physical measurement at a remote location, typically by observing a disturbance to a wave that has passed through that location. Examples include the use of Doppler radar, for electromagnetic waves, and the sensing of various subsurface structures of geological interest, using acoustic waves.

Rather than attempt to make such measurements, the method described herein achieves a similar result by carrying out local sensing and using the results of such local sensing, together with historical data, to computationally infer or estimate conditions at a remote location.

The methods described herein find particular application in weather-related phenomena. However, the techniques are general enough to be used in other applications. For example, in principle machine learning of the same type can be used to estimate ocean currents at otherwise inaccessible locations, or to infer the existence of subsurface structures based on measurements closer to the surface.

In the application described in connection with FIGS. 1 and 2, the payload was unguided and therefore at the mercy of the winds. However, in principle, the payload need not fall unguided. Instead, it can be hung from a parafoil having control surfaces that can be actuated to maneuver the parafoil towards the drop zone. A procedure similar to that described herein can be used to control the parafoil.

In particular, as the parafoil descends, the Earth's atmosphere is continuously being divided into two parts: an upper part through which the parafoil has already descended, and a lower part through which the parafoil has yet to descend. As the parafoil descends, it makes measurements similar to those made by the dropsonde. In effect, the parafoil is acting as its own dropsonde.

The measurements made by the parafoil thus provide a growing body of measurements for the upper part. These measurements can then be used to predict conditions within the lower part. In anticipation of these conditions, the parafoil's control surfaces can be adjusted to adaptively guide it towards the drop zone based at least in part on its observations of atmospheric conditions in the upper part.

This embodiment thus carries out a procedure similar to that discussed in connection with FIGS. 1 and 2, namely the estimation of a phenomenon in a first zone based on a measurement of a similar phenomenon in a second zone remote from the first zone that has been provided to a model created by a machine-learning algorithm that has examined historical data and simulated measurements in an effort to compile a table of transforms that can be applied to the measurement of the phenomenon in the first zone in order to estimate the similar phenomenon in the second zone.

Additional details and experimental results are provided in the attached Appendix, which is incorporated herein by reference.

1. A method comprising delivering a payload to a drop zone, wherein delivering said payload comprises based at least in part on current weather conditions, selecting a remote location at which to measure a remote wind stick, determining a release point, flying to said release point, and dropping said payload from said release point, wherein determining said release point comprises estimating a wind stick at said drop zone based at least in part on said measurement of said remote wind stick.

2. The method of claim 1, wherein selecting said remote location at which to measure said remote wind stick comprises selecting said remote location at least in part on the basis of a confidence level of said estimate of said wind stick at said drop zone.

3. The method of claim 2, further comprising determining said confidence level at least in part on the basis of current weather conditions.

4. The method of claim 1, further comprising releasing a dropsonde at said remote location, collecting data from said dropsonde, and determining said release point based at least in part on said collected data.

5. The method of claim 1, wherein determining said release point comprises providing said remote wind stick to an operational model that has been configured to provide a transformation based on historical weather data and applying said transformation to said remote wind stick to obtain an estimate of a drop-zone wind stick at said drop zone.

6. The method of claim 5, further comprising obtaining said operation model by providing a training model with historical weather data and simulated wind sticks.

7. The method of claim 5, further comprising obtaining said operation model by providing a training model with training data and using boosted regression trees to identify transformations to transform a measurement of a wind stick at a first location into an estimate of a wind stick at a second location.

8. The method of claim 1, further comprising estimating a confidence level of said estimate of said wind stick at said drop zone based at least in part on said current weather conditions.

9. A method comprising obtaining a first value of a variable, providing said first value to an operational model that has been configured by a machine-learning algorithm to provide a transformation to yield an estimate of a value of said variable at a second location, and transforming said first value of said variable to obtain a second value of said variable, wherein said second value of said variable is an estimate of a value of said variable at a remote location, and wherein obtaining said first value comprises measuring said first value at a measurement location that is remote from said remote location.

10. The method of claim 9, wherein said remote location is below a region that contains said measurement location.

11. The method of claim 9, further comprising selecting said variable to be a wind velocity, wherein said first value is a measurement of said wind velocity made at said measurement location, and wherein said second value is an estimate of said wind velocity at a region below said measurement location.

12. The method of claim 9, wherein obtaining a first value of a variable comprises causing a parafoil that is carrying a payload to be delivered to a target location to pass through said measurement location and to collect data while passing through said measurement location, said collected data being indicative of said first value, wherein said second value is an estimate of said wind velocity at a region below said measurement location.

13. The method of claim 9, further comprising delivering a payload to a target, wherein delivering said payload comprise releasing a parafoil carrying said payload from a release point, wherein a force exerted by a current that exists between said release point and said target causes said parafoil to drift as said parafoil falls toward said target, wherein a value of said current that causes said parafoil to drift is based on said variable, wherein said measurement location is between said release point and an intermediate point, and wherein said remote location is between said intermediate point and said target.

14. The method of claim 13, further comprising, based on said estimate, steering said parafoil to correct for said drift.

15. The method of claim 12, wherein obtaining said first value comprises continuously obtaining said first value, wherein transforming said first value to obtain said second value comprises dynamically updating said estimate based at least in part on said continuously obtained first value.

16. The method of claim 15, further comprising dynamically guiding said parafoil toward said target based on said dynamically updated estimate.

17. The method of claim 16, wherein dynamically guiding said parafoil comprises adjusting at least one control surface of said parafoil, thereby controlling force exerted by said current on said parafoil.

18. The method of claim 12, wherein said current is caused by wind velocity.

19. The method of claim 9, wherein said remote location and said measurement location are separated along a circumferential direction that is perpendicular to a line extending to the center of the Earth.
